(19) United States
(12) Patent Application Publication
(10) Pub. No.: US 2010/0330873 A1
(43) Pub. Date: Dec. 30, 2010

(54) TOY VEHICLE LAUNCHER

(76) Inventors: Jim McCafferty, Santa Ana, CA (US); Greg Leong, Irvine, CA (US); Gabriel Carlson, Los Angeles, CA (US); Michael Bernstein, Hermosa Beach, CA (US); Dominic Laurienzo, Los Angeles, CA (US); Dion Fields, Thousand Oaks, CA (US); Steve DeLacy, Santa Ana, CA (US)

Correspondence Address: TOPE-MCKAY & ASSOCIATES;CARY TOPE-MCKAY, #420, 30765 Pacific Coast Highway, Malibu, CA, 90265, US

(21) Appl. No.: 12/712,797

(22) Filed: Feb. 25, 2010

Related U.S. Application Data
(63) Continuation-in-part of application No. 12/587,625, filed on Oct. 10, 2009.
(60) Provisional application No. 61/195,812, filed on Oct. 10, 2008.
(60) Provisional application No. 61/208,490, filed on Feb. 25, 2009.

(51) Int. Cl. A63H 29/00; B23P 17/04

(52) U.S. Cl. 446/429; 29/428

(57) ABSTRACT

Described is a cartridge-loaded toy vehicle launcher track set capable of launching multiple toy vehicles across a variety of tracks. The launcher includes a cartridge for holding a plurality of toy vehicles. A launching mechanism is affixed with a launching body of the launcher for receiving a toy vehicle from the cartridge and launching the toy vehicle from the launching body. Additionally, a track connector is connected with the launching body such that a toy vehicle can be launched from the housing and onto the toy vehicle track when the track is connected with the track connector. In one aspect, a string spool is connected with the launching body such that a toy vehicle can be launched from the housing and onto a string when the string is pulled taut in front of the housing.

### PRIORITY CLAIM

This is a Continuation-in-Part patent application of U.S. patent application Ser. No. 12/587,625 filed in the United States on Oct. 10, 2009, titled, “Mobile Toy with Displaceable Flywheel”, which is a Non-Provisional patent application of expired U.S. Provisional Application No. 61/195,812 filed in the United States on Oct. 10, 2008, titled, “Mobile Toy with Removable Flywheel.” This application is also a Non-Provisional patent application of U.S. Provisional Application No. 61/208,490 filed in the United States on Feb. 25, 2009, titled, “Toy Vehicle Launcher.”

### BACKGROUND OF THE INVENTION

(1) Field of Invention

The present invention relates to a toy vehicle launcher and, more particularly, to a cartridge-loaded launcher capable of launching multiple toy vehicles across a variety of tracks.

(2) Description of Related Art

Toy vehicle launchers for use with toy vehicles have long been known in the art. Conventional launchers include a base for holding a toy vehicle and a propulsion mechanism for propelling the toy vehicle from the base. The propulsion mechanisms come in a variety of forms, from spring-loaded push devices to mechanized wheels that grasp and shoot the toy vehicle from the base.

A drawback with existing vehicle launchers is that they typically launch a single vehicle. Further, existing launchers are formed to operate with a single type of track. Finally, existing launchers are formed to launch typical toy vehicles and do not include a mechanism capable of rotating a flywheel embedded within the toy vehicle and thereafter launching the toy vehicle.

Thus, a continuing need exists for a toy vehicle launcher that is capable of launching multiple toy vehicles with embedded flywheels across a variety of track types.

### SUMMARY OF INVENTION

The present invention relates to a toy vehicle launcher track set and, more particularly, to a cartridge-loaded launcher track set capable of launching multiple toy vehicles across a variety of tracks. The toy vehicle launcher includes a launcher body and a cartridge for holding a plurality of toy vehicles attached with the launcher body. A launching mechanism is affixed with the launcher body for receiving a toy vehicle from the cartridge and launching the toy vehicle from the launcher body. Additionally, a track connector is connected with the launcher body, and the track connector is formed to detachably attach with a toy vehicle track element such that a toy vehicle launched by the launching mechanism is launched from the launcher body and onto the track element when the track element is connected with the track connector.

In another aspect, the cartridge is removably attached with the launcher body.

In another aspect, the toy vehicle launcher track set further comprises a toy vehicle comprising a flywheel.

In yet another aspect, the launching mechanism comprises a drive wheel which engages the flywheel to induce rotation of the flywheel.

In another aspect, a spool is connected with the launcher body, wherein the spool is operable for spooling a string track element from the launcher body such that a toy vehicle launched by the launching mechanism is launched from the launcher body and onto the string track element when the string track element is pulled taut at a point in front of the launcher body.

In yet another aspect, a removable ramp is connected with the launcher body, wherein the removable ramp is connected such that a toy vehicle launched by the launching mechanism is launched down the removable ramp when the removable ramp is connected with the launcher body.

In another aspect, a string spool winder is positioned in the launcher body for winding the string track element.

In another aspect, a bipod is movably connected with the launcher body, wherein the bipod is formed to stabilize the launcher body.

In another aspect, a detachable clamp is detachably attached with the launcher body, wherein the clamp is configured to be attached with an object separate from the launcher.

In another aspect, the removable ramp comprises a track connector, and the removable ramp is detachably attachable with the clamp, such that the string track element can be connected between the launcher and the removable ramp, and the removable ramp can receive the toy vehicle launched from the launcher.

Finally, the present invention also includes a method for forming the device described herein. The method for forming the device includes a plurality of acts of forming and attaching the said components to arrive at the described device.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a side, perspective-view illustration of a toy vehicle launcher according to the present invention;

FIG. 2 is an illustration of a toy vehicle for use with the toy vehicle launcher according to the present invention;

FIG. 3 is an illustration of a toy vehicle launcher with a track connecting the toy vehicle launcher with a vehicle receiving device according to the present invention;

FIG. 4 is a side, perspective-view illustration of a toy vehicle launcher, showing an attached bipod extended; and

FIG. 5 illustrates a cross-sectional view of a toy vehicle launcher, depicting a toy vehicle in the launcher body after being released from the cartridge;

FIG. 6 illustrates a cross-sectional view of a toy vehicle launcher, depicting a cartridge reloader pulled back and the toy vehicle dropped in contact with a drive wheel in the launcher body;

FIG. 7 illustrates a cross-sectional view of a toy vehicle launcher, depicting a cartridge reloader pushed back to lock a toy vehicle against a drive wheel in the launcher; and

FIG. 8 illustrates a cross-sectional view of a toy vehicle launcher, depicting a toy vehicle being propelled from the toy vehicle launcher.

### DETAILED DESCRIPTION

The present invention relates to a toy vehicle launcher track set and, more particularly, to a cartridge-loaded launcher track set capable of launching multiple toy vehicles across a variety of tracks. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C.112, Paragraph 6.

Please note, if used, the labels left, right, front, back, top, bottom, forward, reverse, clockwise and counter clockwise have been used for convenience purposes only and are not intended to imply any particular fixed direction.

Instead, they are used to reflect relative locations and/or directions between various portions of an object.

(1) Description

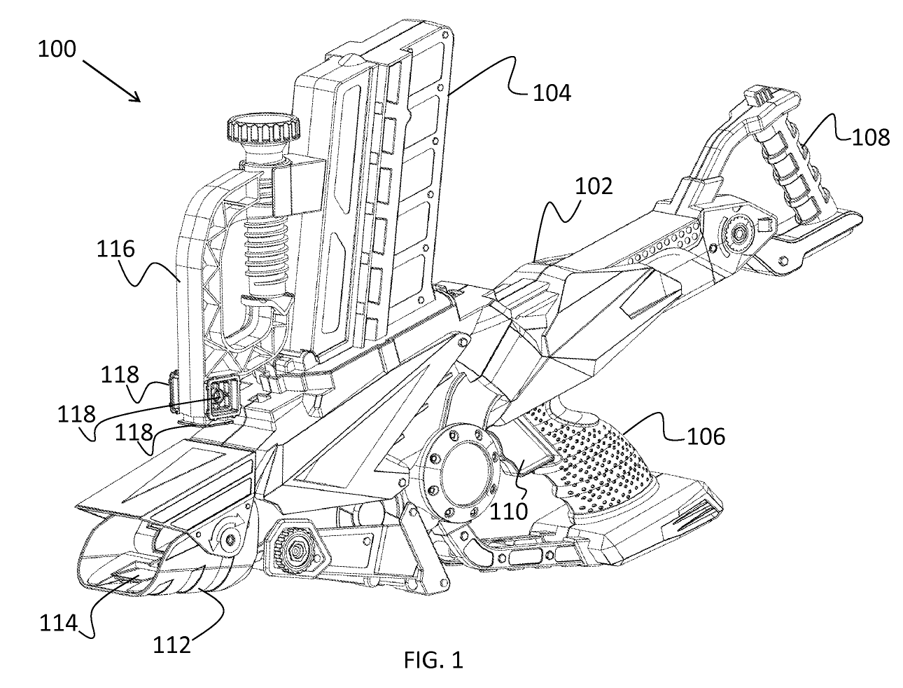

The present invention relates to a toy vehicle launcher and, more particularly, to a cartridge-loaded launcher capable of launching multiple toy vehicles across a variety of tracks. As shown in FIG. 1, the launcher 100 includes a launcher body 102 having an attached cartridge 104, or magazine, that is operable for housing a plurality of toy vehicles. The launcher body 102 further comprises a handle 106 to enable a user to securely grip the launcher 100 during use. Additionally, the launcher 100 includes a cartridge reloader 108 that is used to reload the launcher 100 by retrieving a toy vehicle from the cartridge 104 and loading it into the launcher 100, which will be described in further detail below.

The launcher 100 may be loaded by two methods. In the first method, when the cartridge 104 is not in the launcher body 102, a toy vehicle may be dropped into an opening at the top of the launcher body where the cartridge 104 is usually positioned. With the second method, the toy vehicle is loaded into the cartridge 104 first and then the cartridge 104 is positioned into the launcher body 102. The cartridge 102 is held in place in the launcher 100 by any suitable mechanism, a non-limiting example of which includes a set of spring-loaded tabs. In this aspect, the user removes the cartridge 104 from the launcher body 102 by moving one of the tabs away from the cartridge 104 and rocking the cartridge 104 away from the moved tab. The toy vehicles may be removed from the cartridge 104 by either cycling the toy vehicles through the launcher body 102 or by removing the cartridge 104 from the launcher body 102.

The launcher 100 further comprises a trigger 110 that enables a user to launch the toy vehicle from the launcher 100 and out an exit ramp 112 attached with the launcher body 102. The exit ramp 112 forms a hinged “tunnel” for a toy vehicle to exit through. The launcher 100 is formed to allow a variety of tracks to be detachably attached with the launcher 100 through a track connector 114. The track connector 114 may be any suitable mechanism for connecting with a variety of track elements, non-limiting examples of which include a snap-fit mechanism, a thread and screw configuration, and a tongue that can be positioned within a groove in a track element. In the aspect shown in FIG. 1, the track connector 114 is formed as part of the exit ramp 112. When a track is connected with the track connector 114, the toy vehicle can be launched from the launcher 100 directly onto the track. Alternatively, when the exit ramp 112 is not attached with a track, toy vehicles can be launched directly onto a surface (e.g., floor, table) from the launcher 100.

Furthermore, the launcher 100 comprises a clamp 116 for attachment with an object or surface, a non-limiting example of which includes a table. As shown, the clamp 116 is a screw clamp. However, as can be appreciated by one skilled in the art the clamp 116 may include any suitable clamping mechanism (e.g., spring mechanism) provided it is capable of attaching with an object or surface. In a desired aspect, the clamp 116 is detachable from the launcher body 102, such that the clamp 116 can be attached with a separate object or surface and used to connect a track element (e.g., string) between the launcher body 102 and the clamp 116. In another desired aspect, the clamp 116 includes a plurality of attach points 118. The attach points 118 are used to attach with detachably attachable accessory items, non-limiting examples of which include an anchoring device, the exit ramp 112, and any suitable vehicle receiving device.

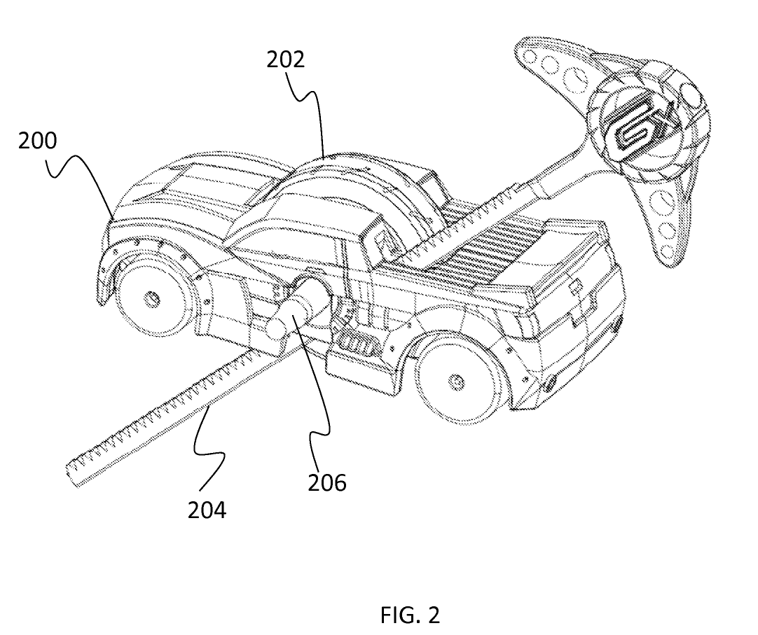

The launcher 100 is formed to operate with a mobile toy vehicle, a non-limiting example of which includes a standard die-cast 1:64 toy vehicle. In a desired aspect and as illustrated in FIG. 2, the launcher is formed to operate with a toy vehicle 200 that includes a flywheel 202. The flywheel 202 extends through an aperture of the bottom of the toy vehicle 200, and at least a portion of the flywheel extends through an aperture of the top portion of the toy vehicle 200. The portion of the flywheel 202 which extends through the aperture of the bottom portion is able to contact a surface (e.g., ground surface, track) below the toy vehicle 200 to propel the toy vehicle 200. In a desired aspect, the flywheel 202 includes an indentation around its circumference that allows it to run along a track element, a non-limiting example of which includes a string.

As can be appreciated by one skilled in the art, the flywheel 202 may be comprised of any suitable material which allows the flywheel to perform its intended function. Non-limiting examples of tread styles for a tire of the flywheel 202 include rain slick, off-road, and motorcycle. In a desired aspect, the flywheel 202 includes grooves along its rim to allow placement of various interchangeable O-rings. The O-rings may include a variety of sizes, shapes, and textures to change the overall appearance of the flywheel. The grooves may also allow placement of interchangeable tread styles. Alternatively, the grooves can be used so that the flywheel 202 can grip and roll along a thin track element (e.g., wire, string, thin rail) with the thin track element passing through the groove as the flywheel 202 rotates and carries the toy vehicle 200 along the thin track element.

It should be understood that the toy vehicle 200 requires an intrinsic power means (e.g., the flywheel 202, which can be weighted) to propel the toy vehicle 200 across a surface. It is the intrinsic power means that drives the toy vehicle 200 from the launcher 100 and across a surface. The flywheel 202 may be powered through any suitable mechanism or device, a non-limiting example of which includes a rip cord 204 that is connectable with a gear attached with the flywheel 202 to induce rotation of the flywheel 202. In a desired aspect, the flywheel 202 is powered by a launching mechanism affixed within the launcher (in FIG. 1). As can be appreciated by one skilled in the art, the launching mechanism may be any suitable mechanism or device capable of rotating the flywheel 202. In a desired aspect, the launcher includes a direct drive system that includes a drive wheel that engages with the flywheel 202 when the toy vehicle 200 is loaded into the launcher.

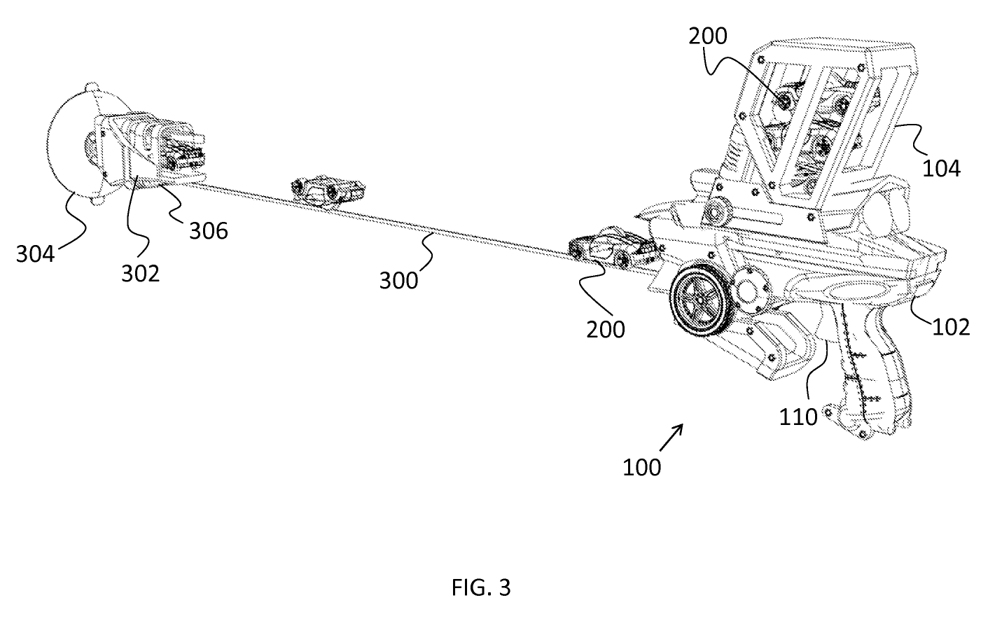

FIG. 3 depicts the launcher 100 attached with a track element 300, shown as a string. As can be appreciated by one skilled in the art, the track element 300 may be a conventional track or any other suitable track element upon which the toy vehicle 200 can travel, a non-limiting example of which includes a string, wire, or thin rail. As described above, the launcher body 102 comprises a track connector for removably connecting the track element 300 with the launcher body 102. In a desired aspect, the launcher 100 further comprises a detachable vehicle receiving device 302 (shown as detached) which is detachably attachable with the launcher body 102. Additionally, a removable anchoring device 304 (a non-limiting example of which includes a suction cup as shown) is detachably attachable with the launcher body 102 for use with the vehicle receiving device 302 and/or the launcher 100. As can be appreciated by one skilled in the art, the anchoring device 304 can be used to anchor the detachable vehicle receiving device 302 to a surface. In a desired aspect, the anchoring device 304 and/or the vehicle receiving device 302 can be detachably attached with one of the attach points on the clamp of the launcher 100.

In the aspect shown in FIG. 3, the anchoring device 304 (e.g., suction cup, clamp, or other suitable anchoring device) and the vehicle receiving device 302 are removed from the launcher body 102 and attached with a separate surface (e.g., a wall) opposite the launcher 100. A track element 300 (e.g., string) is drawn from the launcher 100 and attached with the vehicle receiving device 302 (or other foreign item). In a desired aspect, the launcher 100 includes a string taut mechanism to keep the string tight between the detachable track item 302 and the launcher 100. As a non-limiting example, the launcher 100 includes a spring-loaded spool that is constantly attempting to rewind the string once it is drawn from the spool, thereby keeping the string taut. Once taut, the toy vehicle 200 can be launched from the launcher 100, where it travels down the track element 300 and onto a surface or into contact with the detachable vehicle receiving device 302.

The vehicle receiving device 302 is any suitable mechanism or device that can receive a toy vehicle, a non-limiting example of which includes a jump or the exit ramp described above. As another non-limiting example and as depicted in FIG. 3, the vehicle receiving device 302 is a rotational element that receives the toy vehicle 200 and then rotates to turn it upside down. Once upside down, the flywheel operates to return the toy vehicle 200 to the launcher 100. The vehicle receiving device 302 further comprises a track attachment element 306 for attaching the track element 300 (e.g., string, conventional track) connected with the launcher body 102 to the vehicle receiving device 302.

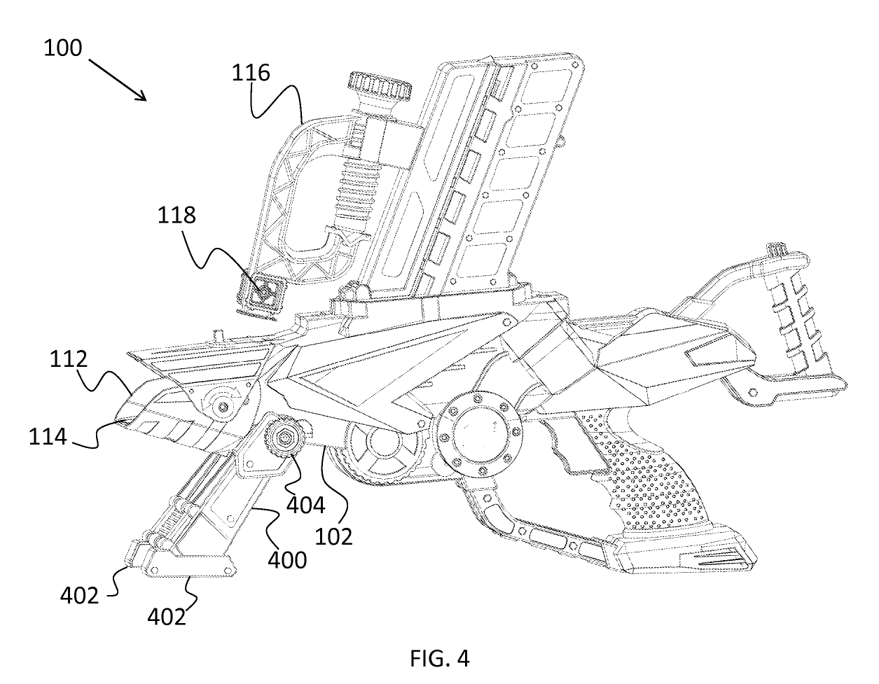

In one aspect, and as shown in FIG. 4, the launcher 100 is further equipped with a forward bipod 400 having two legs 402 movably connected with the launcher body 102 through a pivot point 404. When the launcher 100 is connected with a conventional toy vehicle track, the bipod 400 is swung forward so that it is parallel with the launcher body 102. The launcher 100 can then be placed on a surface (e.g., floor, table). A user connects a track element to the track connector 114 on the exit ramp 112, so that the track element is even with an opening in the launch body 102. Thus, when the toy vehicle exits the launcher 100, it will travel down the connected track. Alternatively, when the launcher 100 is used with a string (or wire or thin rail) drawn from the launcher 100, the bipod 400 can be swung upright so that it is perpendicular with the launcher body 102, as depicted in FIG. 4. When the launcher 100 is placed on a surface (e.g., table, floor) with the bipod 400 down, the launcher body 102 will sit parallel to and above the surface.

In a desired aspect, the exit ramp 112 is formed to be removable from the launcher body 102 to act as a vehicle receiving device. In this aspect, the clamp 116 is removed and attached with an object (e.g., table) and the exit ramp 112 is attached with one of the attach points 118 of the clamp 116. A string drawn from the launcher 100 is then connected with the exit ramp 112 through a string connector (not shown), the track connector 114, or any suitable mechanism to connect a string to a portion of the exit ramp 112. Thus, in this configuration, the toy vehicle launched from the launcher 100 is able to be travel down the string towards the detached exit ramp 112 (attached with the clamp 116 to an object) located at a distance from the launcher 100.

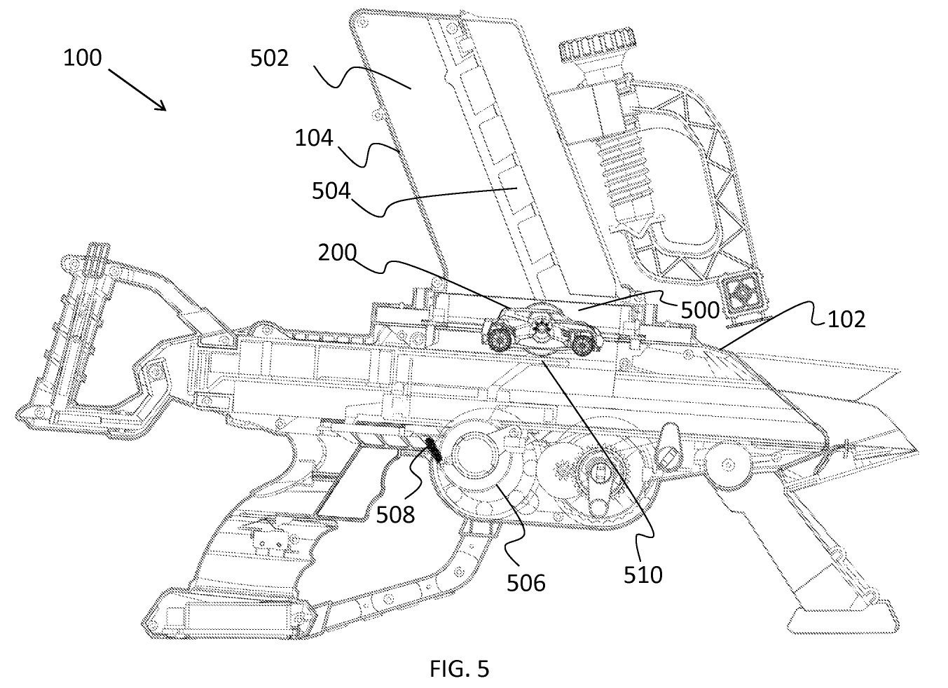

FIGS. 5 through 8 illustrate cross-sectional views of the launcher 100 depicting a process by which a toy vehicle 200 is loaded into the launcher 100 and launched from the launcher 100. As shown in FIG. 5, the toy vehicle 200 is being dropped from the cartridge 104 into the launcher body 102. The cartridge 104 is formed to hold multiple toy vehicles (e.g., up to five) and is configured so that there is a first opening 500 in the cartridge 104 that opens to the launcher body 102. The first opening 500 includes a door that is closed until the cartridge 104 is fit into the launcher body 102, at which time the door opens automatically (e.g., spring-loaded trap door). A second opening 502 is located near a closed end of the cartridge 104 such that it faces the user when the user is holding the launcher 100. Toy vehicles 200 are pushed into the second opening, and the toy vehicles 200 fall into position against the first opening 500. As described above, in a desired aspect the launcher 100 is formed to operate with a toy vehicle 200 that includes a flywheel. As shown in FIG. 2, an axle extending through the flywheel 202 includes axle extensions 206. FIG. 4 illustrates the cartridge 104 with a plurality of slots 504 for receiving the axle extensions and holding the toy vehicles within the cartridge by the axle extensions (or any other suitable protrusions on the toy vehicle).

Additionally, as illustrated in FIG. 5, the launcher 100 comprises a drive wheel 506 housed within the launcher body 102. As described above, the launcher 100 includes a direct drive system that includes a drive wheel 506 that engages with the flywheel when the toy vehicle 200 is loaded into the launcher 100. A spring 508 keeps the drive wheel 506 in contact with the flywheel of the toy vehicle 200. The drive system further comprises a platform 510 which holds the toy vehicle 200 after it has been dropped from the cartridge 104 but before it has been placed in contact with the drive wheel 506.

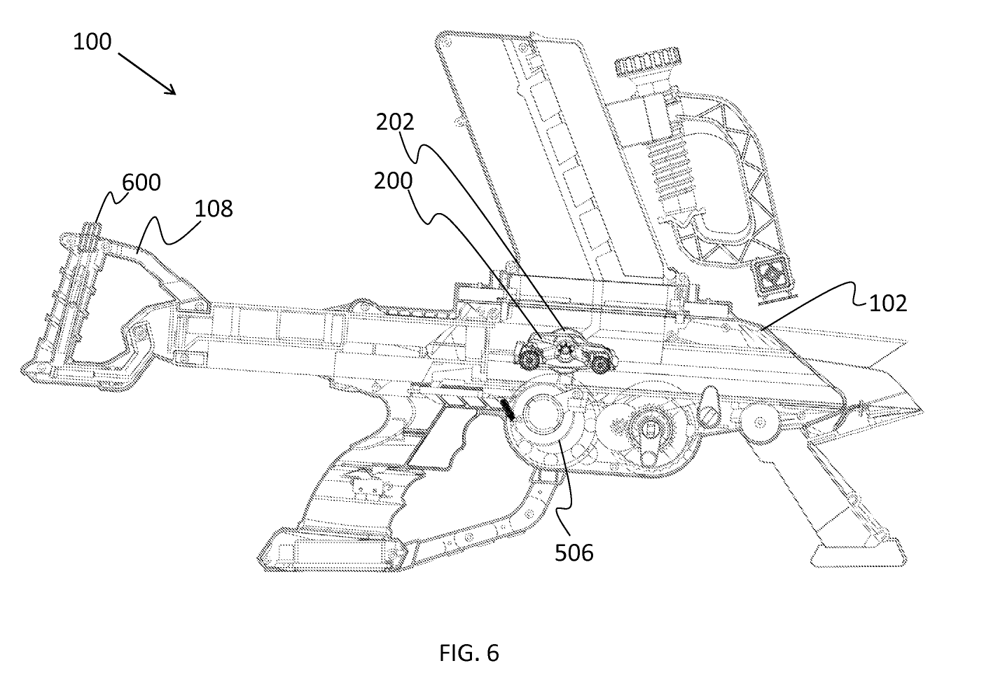

As shown in FIG. 6, the toy vehicle 200 drops into place and the flywheel 202 makes contact with the drive wheel 506 when a push button 600 on the cartridge reloader 108 is pressed and the cartridge reloader 108 is pulled back towards the user. When the cartridge reloader 108 is pulled, the platform 510 is released to allow the toy vehicle 200 to drop further into the launcher body 102 where the flywheel 202 engages with the drive wheel 506.

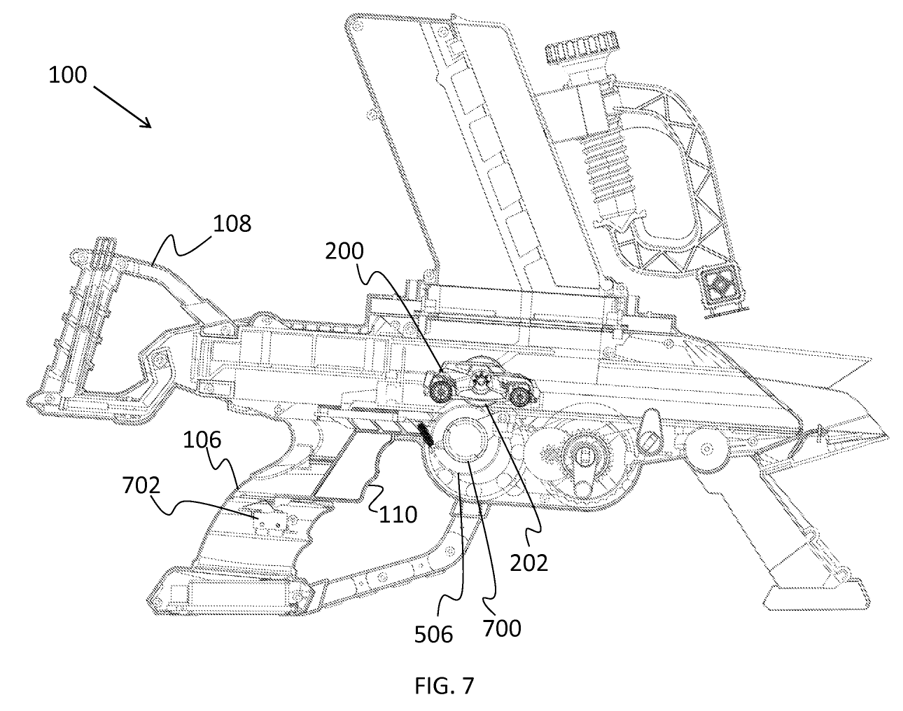

FIG. 7 illustrates the cartridge reloader 108 pushed forward into its original position. When the cartridge reloader 108 is pulled then pushed forward, the toy vehicle 200 is locked into place. A user then pulls the trigger 110 halfway to turn on the drive wheel motor 700 which is controlled by a switch 702 housed in the handle 106. The drive wheel motor 700 causes the drive wheel 506 to start to rotate which, in turn, causes the flywheel 202 to rotate.

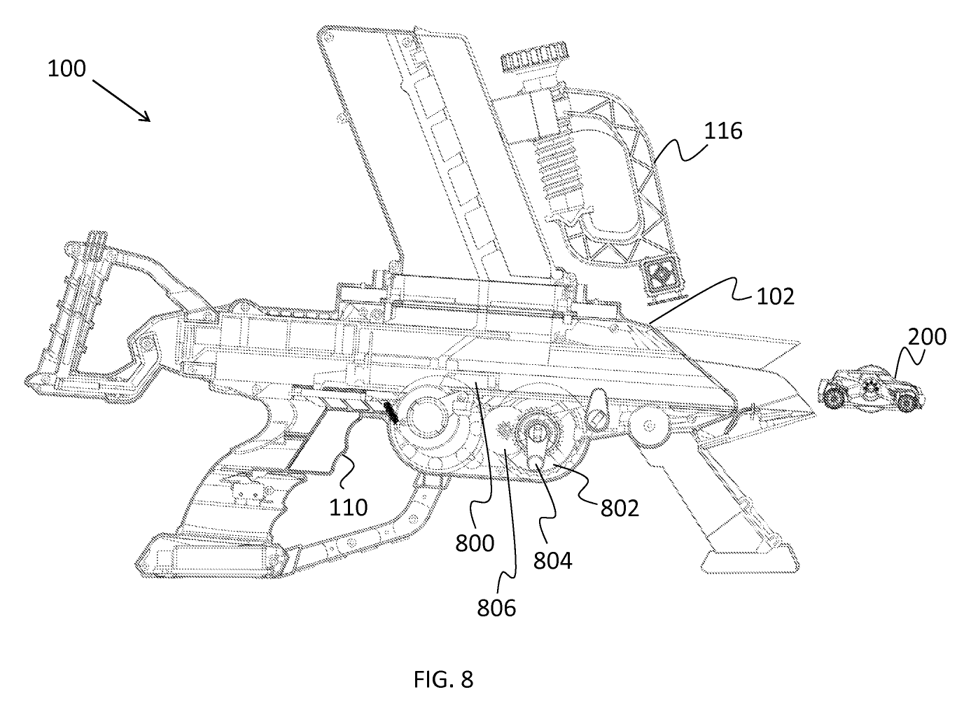

Once the flywheel in the toy vehicle 200 reaches a desired speed, the trigger 110 can be pulled back completely which releases a catch 800 that was holding the toy vehicle 200 in place, as illustrated in FIG. 8. The catch 800 holds the axle extensions of the toy vehicle 200. When it is activated, the catch 800 drops out of the way, allowing the toy vehicle 200 to coast forward and out of the launcher 100. With the catch 800 released, the rotating flywheel is now capable of propelling the toy vehicle 200 forward and out of the launcher 100.

In a desired aspect, and as shown in FIG. 8, a spool 802 and string spool winder 804 are positioned at the front of the launcher body 102. When the string spool winder 804 is set into a loose position, the string can be pulled out and attached to a detachable clamp 116 or detachable vehicle receiving device (e.g., ramp or rotational element), as described above. The string spool winder 804 is then set into a tight position and the launcher 100 is pulled towards the user until the string is taut. Thus, when the toy vehicle 200 exits the launcher 100, it will travel down the track, in this case a string. After play, the string spool winder 804 is set to the loose position and the string is manually wound back into the launcher 100. Alternatively, the spool 802 may be spring-loaded, such that it automatically retracts and winds the string upon the spool 802. As a non-limiting example, at least one gear 806 in contact with both the string spool winder 804 and the spool 802 helps rapidly rewind the string by changing the gearing between the string spool winder 804 and the spool 802.

What is claimed is:

1. A toy vehicle launcher track set for launching a toy vehicle, comprising:
a launcher body;
a cartridge for holding a plurality of toy vehicles attached with the launcher body;
a launching mechanism affixed with the launcher body for receiving a toy vehicle from the cartridge and launching the toy vehicle from the launcher body; and
a track connector connected with the launcher body, the track connector formed to detachably attach with a toy vehicle track element such that a toy vehicle launched by the launching mechanism is launched from the launcher body and onto the track element when the track element is connected with the track connector.

2. The toy vehicle launcher track set as set forth in claim 1, wherein the cartridge is removably attached with the launcher body.

3. The toy vehicle launcher track set as set forth in claim 2, further comprising a toy vehicle that comprises a flywheel.

4. The toy vehicle launcher track set as set forth in claim 3, wherein the launching mechanism comprises a drive wheel which engages the flywheel to induce rotation of the flywheel.

5. The toy vehicle launcher track set as set forth in claim 4, further comprising a spool connected with the launcher body, the spool operable for spooling a string track element from the launcher body such that a toy vehicle launched by the launching mechanism is launched from the launcher body and onto the string track element when the string track element is pulled taut at a point in front of the launcher body.

6. The toy vehicle launcher track set as set forth in claim 5, further comprising a removable ramp connected with the launcher body, the removable ramp connected such that a toy vehicle launched by the launching mechanism is launched down the removable ramp when the removable ramp is connected with the launcher body.

7. The toy vehicle launcher track set as set forth in claim 6, further comprising a string spool winder positioned in the launcher body for winding the string track element.

8. The toy vehicle launcher track set as set forth in claim 7, further comprising a bipod movably connected with the launcher body, wherein the bipod is formed to stabilize the launcher body.

9. The toy vehicle launcher track set as set forth in claim 8, further comprising a detachable clamp detachably attached with the launcher body, wherein the clamp is configured to be attached with an object separate from the launcher.

10. The toy vehicle launcher as set forth in claim 9, wherein the removable ramp comprises a track connector, and wherein the removable ramp is detachably attachable with the clamp, such that the string track element can be connected between the launcher, and the removable ramp and the removable ramp can receive the toy vehicle launched from the launcher.

11. A method for forming a toy vehicle launcher track set for launching a toy vehicle, comprising acts of:
forming a launcher body;
forming a cartridge for holding a plurality of toy vehicles and attaching the cartridge with the launcher body;
affixing a launching mechanism with the launcher body for receiving a toy vehicle from the cartridge and launching the toy vehicle from the launcher body; and
forming a track connector and connecting the track connector with the launcher body, wherein the track connector is formed to detachably attach with a toy vehicle track element such that a toy vehicle launched by the launching mechanism is launched from the launcher body and onto the track element when the track element is connected with the track connector.

12. The method for forming the toy vehicle launcher track set as set forth in claim 11, further comprising an act of forming the cartridge to be removably attached with the launcher body.

13. The method for forming the toy vehicle launcher track set as set forth in claim 12, further comprising an act of forming a toy vehicle that comprises a flywheel.

14. The method for forming the toy vehicle launcher track set as set forth in claim 13, further comprising an act of forming the launching mechanism to have a drive wheel which engages the flywheel to induce rotation of the flywheel.

15. The method for forming the toy vehicle launcher track set as set forth in claim 14, further comprising an act of forming a spool connected with the launcher body, wherein the spool is formed to be operable for spooling a string track element from the launcher body, such that a toy vehicle launched by the launching mechanism is launched from the launcher body and onto the string track element when the string track element is pulled taut at a point in front of the launcher body.

16. The method for forming the toy vehicle launcher track set as set forth in claim 15, further comprising an act of forming a removable ramp connected with the launcher body, such that a toy vehicle launched by the launching mechanism is launched down the removable ramp when the removable ramp is connected with the launcher body.

17. The method for forming the toy vehicle launcher track set as set forth in claim 16, further comprising an act of forming a string spool winder positioned in the launcher body for winding the string track element.

18. The method for forming a toy vehicle launcher track set as set forth in claim 17, further comprising an act of forming a bipod movably connected with the launcher body, wherein the bipod is formed to stabilize the launcher body.

19. The method for forming a toy vehicle launcher track set as set forth in claim 18, further comprising an act of forming a detachable clamp detachably attached with the launcher body, wherein the clamp is configured to be attached with an object separate from the launcher.

20. The method for forming a toy vehicle launcher track set as set forth in claim 19, further comprising acts of forming a track connector on the removable ramp and forming the removable ramp to be detachably attachable with the clamp, such that the string track element can be connected between the launcher and the removable ramp, and the removable ramp can receive the toy vehicle launched from the launcher.
